(19) United States
(12) Patent Application Publication
(10) Pub. No.: US 2006/0236259 A1
(43) Pub. Date: Oct. 19, 2006

(54) Electronic library

(76) Inventor: Tinashe Benjamin Muchada, London (GB)

Correspondence Address: OLIFF & BERRIDGE, PLC, P.O. BOX 19928, ALEXANDRIA, VA, 22320, US

(21) Appl. No.: 10/564,891

(22) PCT Filed: Jul. 14, 2003
(86) PCT No.: PCT/GB03/03019

§ 371 Date: Jan. 17, 2006

(51) Int. Cl. G06F 3/00

(52) U.S. Cl. 715/776

(57) ABSTRACT

The electronic library is an electronic user interface for use in a library where the books/items are stored away from the user accessible area. Users are therefore not in contact with the hard copies of books/items but can view electronic copies of them on the electronic user interface. From there they may request the hard copies. A robotic system may be employed for the delivery of hard copies.

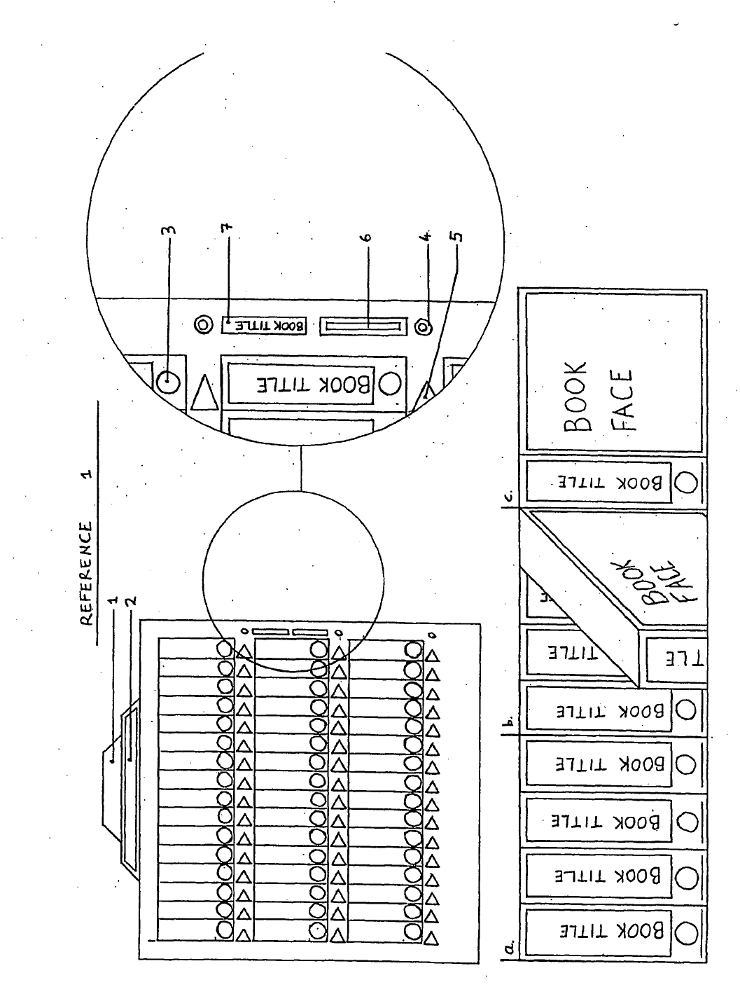

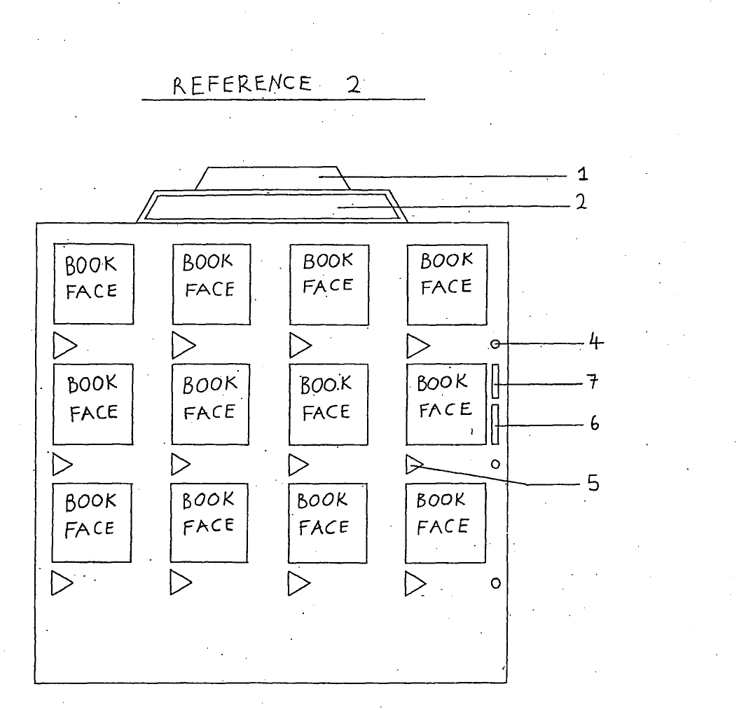

The aim of the electronic library is to provide an electronic user interface in a library where the books/items are stored away from the user. Users will be able to view digital copies of books and request the hard copy from this user interface. There would have to be an automatic system of issuing books/items to go with the interface so that when books/items are requested they are automatically issued to the user. There are advantages of such a separate user interface/book storage system and these are discussed below.
1. The digital copy of every title the library holds even if it's fully leased out at the time is available for viewing by the user at the electronic interface.
2. Storing the books/items separate from the user area presents a great opportunity for space efficiency. For instance, books or items can be stacked as high as the ceiling, something which would be impossible to do if the books/items were stored in the user area where the user had to able to access the books/items.
3. There will be better security in the library as there is stricter control of access to hard copies of books/items.
4. The system gives a good chance for the employment of automatic robotic systems in the library instead of the traditional manual labour.

Note that I am referring to a library with books or items because this system is not confined to the conventional book library but can also be used in other scenarios such as a retail environment where items being sold are kept away from the shoppers and they can view digital copies of the items on the electronic interface. They may then request the items just as with the library scenario.

I will now describe the electronic interface and how it works with the aid of the drawings. The electronic interface is based on ‘book-size’ screens called electronic books replacing the hard copy in the user area To aid the adaptation of users to the system, these electronic books are securely mounted on cabinets as hard copies would be on shelves in a conventional book library. Reference 1 shows the electronic books mounted on a cabinet.

The electronic book is basically shaped like a book and has two screens, one as the title screen and the other as the book face. The title screen is visible when the book is mounted on the cabinet and displays the book's title. The book face is where the electronic copy of the book may be viewed. Note that the book face is hidden from view when the electronic book is mounted on the cabinet.

Each cabinet has its own title screen, which displays the family name of the electronic books on that cabinet. There is also a sensor, feature 1 on each cabinet, which senses if a user is approaching the cabinet. This means that the title screens can be turned off until a user arrives or might all collectively form a giant screen on which advertisements might be shown. These would then have to be turned off when a user approaches the cabinet.

To view an electronic book, the user has to press the request button, feature 3, on the relevant electronic book. The book would then mechanically protrude out of the cabinet as shown in b; and then turn sideways to expose the book face as in c. The user may then the digital copy of the book/item on the book face. There will be options on the electronic book, one of which is request for the hard copy, which can be selected on the screen because the screen would be a touch screen. If the screen is not a touch screen then there will buttons on the electronic book with which the select options.

If the user chose to request a hard copy then they would have to put in their user card into the user card slot of the cabinet, feature 6, so that details can be added to their file. Note that the user interface is connected to a computer system which handles all the applications mentioned herein which would need a computer and software. The title screen on top of the card slot displays the book/item requested by the user whose card is required at the time.

In the case that a user wants to view the electronic book that another user is viewing then the user may replicate the book using feature 5, the replication request, which replicates the electronic book on the electronic book to the right of the original. The user may continue to press the relevant button until the electronic book is conveniently placed for them. This shift of books is only temporary.

As this is an electronic system, it is easy to have many inbuilt features in the electronic books. One of these is audio versions of books or commentaries of books/items. If the user wishes to use such a facility they could insert earphones in the socket, feature 4. Wireless earphones may be used to improve user mobility.

Note that Reference 1 shows the preferred embodiment of the invention. Another embodiment is shown in Reference 2. This embodiment has no need for mechanised electronic books as the electronic books' faces are permanently exposed. All the functions of this embodiment are the same as those described for the embodiment in Reference 1.

### REFERENCES 1 & 2 (ANNOTATIONS)

1. Sensor
2. Cabinet Title Screen
3. Book Request button (See a, b, and c below for use)
4. Earphone socket
5. Book Shift/Replication Request. Used to move Books from one electronic book from which it can not be read maybe because it is obstructed by another user to one when it can be read or simply to replicate a book being used by another user. After this service has been used, normal book order is restored.
6. User Card Slot
7. User Card Slot Display. It displays the title of the book being viewed by the user who needs to use the slot at that time. If there are more than one users who wish to use the slot they will use in the order their book titles are displayed on this screen.
   a. Normal cabinet scenario. Book request Button is pressed.
   b. Electronic book comes out of the cabinet.
   c. Electronic book rotates so as to show the touch screen (book face) on which the contents of the book and options are accessed.
      See Reference 1 (Drawings).

1. A user interface consisting of electronic books mounted on a cabinet.

2. The cabinet as claimed in claim 1 on which there is a sensor to detect approach of users.

3. The cabinet as claimed in claim 1, which has earphone sockets for audio applications.

4. The electronic books as in claim 1 mechanised so they can protrude out of the cabinet on request.

5. The cabinet as claimed in claim 2, which has earphone sockets for audio applications.
